(19) United States
(12) Patent Application Publication
(10) Pub. No.: US 2007/0042926 A1
(43) Pub. Date: Feb. 22, 2007

(54) Process for preparing a solid laundry detergent composition, comprising at least two drying steps

(76) Inventor: Nigel Patrick Somerville Roberts, Newcastle-upon-Tyne (GB)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/505,004

(22) Filed: Aug. 16, 2006

(30) Foreign Application Priority Data
Aug. 19, 2005 (EP) 05018032.2

(51) Int. Cl. C11D 17/00

(52) U.S. Cl. 510/444

(57) ABSTRACT

The present invention relates to a process for preparing a solid laundry detergent composition comprising: (a) anionic detersive surfactant; (b) from 0% to less than 5%, by weight of the composition, of zeolite builder; (c) from 0% to less than 5%, by weight of the composition, of phosphate builder; and (d) optionally, from 0% to less than 5%, by weight of the composition, of silicate salt; wherein the process comprises the steps of: (i) preparing an aqueous mixture comprising an anionic detersive surfactant; (ii) subjecting the aqueous mixture to a first drying step having a mean drying-duration time of less than 60 seconds and a mean drying rate of from 0.005 to 0.030 kg of water per kg of aqueous mixture per second to form a partially dried aqueous mixture; and (iii) subjecting the partially dried aqueous mixture to a second drying step having a mean drying-duration time of at least 10 seconds and a mean drying rate of from 0.0005 to less than 0.030 kg of water per kg of partially dried aqueous mixture per second to form a solid laundry detergent composition, wherein the ratio of the mean drying rate in the first drying step to the mean drying rate in the second drying step is greater than 1:1, and wherein the ratio of the mean drying-duration time of the second drying step to the mean drying-duration time of the first drying step is greater than 1:1.

### FIELD OF THE INVENTION

The present invention relates to a process for preparing a solid laundry detergent composition, comprising at least two drying steps. The compositions made in accordance with the process of the present invention have a good cleaning performance, good dispensing and dissolution profiles, and good physical characteristics, especially after storage.

### BACKGROUND OF THE INVENTION

There have been relatively recent attempts by many detergent manufacturers to significantly improve the dissolution and dispensing performance of their granular laundry detergents. The approach many detergent manufacturers have focused on is the significant reduction in the level of, or even the complete removal of, water-insoluble builder, such as zeolite builder, in/from their granular laundry detergent formulations. However, due to the phosphate-usage avoidance legislation in many countries which prevents the detergent manufacturers from incorporating a sufficient amount of phosphate-based water-soluble builders, such as sodium tripolyphosphate, in their granular laundry detergents, and due to the lack of feasible alternative non-phosphate based water-soluble builders available to the detergent manufacturers, the approach many detergent manufacturers have focused on is to not completely replace the zeolite-based builder system with a water-soluble builder system having an equivalent degree of builder capability, but instead to formulate an under-built granular laundry detergent composition.

Whilst this under-built approach does significantly improve the dissolution and dispensing performance of the granular laundry detergent, problems do exist due to the significant amount of cations, such as calcium, that are not removed from the wash liquor by the builder-system of the granular laundry detergent composition during the laundering process. These cations interfere with the anionic detersive surfactant system of the granular laundry detergent composition in such a manner as to cause the anionic detersive surfactant to precipitate out of solution, which leads to a reduction in the anionic detersive surfactant activity and cleaning performance. In extreme cases, these water-insoluble complexes may deposit onto the fabric resulting in poor whiteness maintenance and poor fabric integrity benefits. This is especially problematic when the laundry detergent is used in hard-water washing conditions when there is a high concentration of calcium cations.

Another problem that needs to be overcome when the level of water-insoluble builders such as zeolite are significantly reduced in the composition, or when the zeolite is completely removed from the formulation, is the poor physical characteristics of the composition, especially after storage, which result in a poor cake strength.

The Inventors have found that the cleaning performance and physical characteristics of under-built solid laundry detergent compositions are improved when the composition is prepared by a process having at least two drying steps and wherein the mean drying-rates and the mean drying-duration times the drying steps are carefully controlled relative to each other. The process of present invention ensures that the resultant under-built solid laundry detergent compositions have a very low relative humidity whilst also ensuring that the thermal decomposition of the ingredients present in the composition is negated.

U.S. Pat. No. 5,552,078 by Carr et al, Church & Dwight Co. Inc., relates to a powdered laundry detergent composition comprising an active surfactant. It is alleged that compositions of U.S. Pat. No. 5,552,078 exhibit excellent cleaning and whitening of fabrics whilst avoiding the problem of eutrophication which occurs when a substantial amount of phosphate-builder is present in the composition, and while minimizing the problem of fabric-encrustation often present when the composition contains a large amount of carbonate builder.

U.S. Pat. No. 6,274,545 B1 by Mazzola, Church & Dwight Co. Inc., relates to a high-carbonate low-phosphate powder laundry detergent formulation which can allegedly be utilized in cold water fabric laundering with a minimized remainder of undissolved detergent residue in the wash liquor.

WO97/43366 by Askew et al, The Procter & Gamble Company, relates to a detergent composition that comprises an effervescence system. WO97/43366 exemplifies a carbonate built bleach-free detergent composition.

WO00/18873 by Hartshorn et al, The Procter & Gamble Company, relates to detergent compositions having allegedly good dispensing performance and allegedly do not leave residues on the fabric after the laundering process.

WO00/18859 by Hartshorn et al, The Procter & Gamble Company, relates to detergent compositions allegedly having an improved delivery of ingredients into the wash liquor during the laundering process. The compositions of WO00/18859 allegedly do not as readily gel upon contact with water and allegedly do not leave water-insoluble residues on clothes after the laundering process. The compositions of WO00/18859 comprise a predominantly water-soluble builder system that is intimately mixed with a surfactant system.

WO02/053691 by Van der Hoeven et al, Hindustain Lever Limited, relates to a laundry detergent composition comprising greater than 10 wt% of a calcium tolerant surfactant, from 0.1 wt% to 10 wt% of a strong builder system selected from phosphate builders and/or zeolite builders, and less than 35wt% of non-functional non-alkaline water-soluble inorganic salts.

### SUMMARY OF THE INVENTION

The present invention provides a process for preparing a solid laundry detergent composition comprising: (a) anionic detersive surfactant; (b) from 0% to less than 5%, by weight of the composition, of a zeolite builder; (c) from 0% to less than 5%, by weight of the composition, of a phosphate builder; and (d) optionally, from 0% to less than 5%, by weight of the composition, of a silicate salt; wherein the process comprises the steps of: (i) preparing an aqueous mixture comprising an anionic detersive surfactant; (ii) subjecting the aqueous mixture to a first drying step having a drying-duration time of less than 60 seconds and a drying rate of from 0.005 to 0.030 kg of water per kg of aqueous mixture per second to form a partially dried aqueous mixture; and (iii) subjecting the partially dried aqueous mixture to a second drying step having a drying-duration time of at least 10 seconds and a drying rate of from 0.0005 to less than 0.030 kg of water per kg of partially dried aqueous mixture per second to form a solid laundry detergent composition.

Preferably, the ratio of the drying rate in the first drying step to the drying rate in the second drying step is greater than 1:1.

Preferably the ratio of the drying-duration time of the second drying step to the drying-duration time of the first drying step is greater than 1:1.

### DETAILED DESCRIPTION OF THE INVENTION

Solid Laundry Detergent Composition

The composition comprises anionic detersive surfactant, from 0 to less than 5%, by weight of the composition, of zeolite builder, from 0% to less than 5%, by weight of the composition, of phosphate builder, and optionally from 0% to less than 5%, by weight of the composition, of silicate salt. The composition may also comprise adjunct ingredients.

The composition is typically in particulate form, such as an agglomerate, a spray-dried power, an extrudate, a flake, a needle, a noodle, a bead, or any combination thereof. The composition may be in the form of a compacted-particulate form such as in the form of a tablet. The composition may be in some other unit dose form, such as in the form of a pouch; typically being at least partially, preferably essentially completely, enclosed by a water-soluble film such as polyvinyl alcohol. Preferably, the composition is in free-flowing particulate form; by free-flowing particulate form, it is typically meant that the composition is in the form of separate discrete particles. The composition may be made by any suitable method including agglomeration, spray-drying, extrusion, mixing, dry-mixing, liquid spray-on, roller compaction, spheronisation, tabletting or any combination thereof.

The composition typically has a bulk density of from 450 g/l to 1,000 g/l, preferred low bulk density detergent compositions have a bulk density of from 550 g/l to 650 g/l and preferred high bulk density detergent compositions have a bulk density of from 750 g/l to 900 g/l.

During the laundering process, the composition is typically contacted with water to form a wash liquor having a pH of from above 7 to less than 13, preferably from above 7 to less than 10.5. This is the optimal pH to provide good cleaning whilst also ensuring a good fabric care profile.

The composition typically has an equilibrium relative humidity of from 0% to less than 30%, preferably from 0% to 20%, or from 0% to 10% when measured at a temperature of 35° C. Typically, the equilibrium relative humidity is determined as follows: 300 g of composition is placed in a 1 litre container made of a water-impermeable material and fitted with a lid capable of sealing the container. The lid is provided with a sealable hole adapted to allow insertion of a probe into the interior of the container. The container and its contents are maintained at a temperature of 35° C. for 24 hours to allow temperature equilibration. A solid state hygrometer (Hygrotest 6100 sold by Testoterm Ltd, Hapshire, UK) is used to measure the water vapour pressure. This is done by inserting the probe into the interior of the container via the sealable hole in the container's lid and measuring the water vapour pressure of the head space. These measurements are made at 10 minute intervals until the water vapour pressure has equilibrated. The probe then automatically converts the water vapour pressure reading into an equilibrium relative humidity value.

Preferably, the composition upon contact with water at a concentration of 9.2 g/l and at a temperature of 20° C. forms a transparent wash liquor having (i) a turbidity of less than 500 nephelometric turbidity units; and (ii) a pH in the range of from 8 to 12. Preferably, the resultant wash liquor has a turbidity of less than 400, or less than 300, or from 10 to 300 nephelometric turbidity units. The turbidity of the wash liquor is typically measured using a H193703 microprocessor turbidity meter. A typical method for measuring the turbidity of the wash liquor is as follows: 9.2 g of composition is added to 1 litre of water in a beaker to form a solution. The solution is stirred for 5 minutes at 600 rpm at 20° C. The turbidity of the solution is then measured using a H193703 microprocessor turbidity meter following the manufacturer's instructions.

Anionic Detersive Surfactant

The detergent composition comprises anionic detersive surfactant. Preferably, the composition comprises from 5% to 25%, by weight of the composition, of anionic detersive surfactant. Preferably, the composition comprises from 6% to 20%, or from 7% to 18%, or from 8% to 15%, or from 8% to 11% or even from 9% to 10%, by weight of the composition, of anionic detersive surfactant. The anionic detersive surfactant is preferably selected from the group consisting of: linear or branched, substituted or unsubstituted C₈₋₁₈ alkyl sulphates; linear or branched, substituted or unsubstituted C₈₋₁₈ linear alkylbenzene sulphonates; linear or branched, substituted or unsubstituted C₈₋₁₈ alkyl alkoxylated sulphates having an average degree of alkoxylation of from 1 to 20; linear or branched, substituted or unsubstituted C₁₂₋₁₈ alkyl carboxylates; and mixtures thereof. The anionic detersive surfactant can be an alkyl sulphate, an alkyl sulphonate, an alkyl phosphate, an alkyl phosphonate, an alkyl carboxylate or any mixture thereof. The anionic surfactant can be selected from the group consisting of: C₁₀-C₁₈ alkyl benzene sulphonates (LAS), preferably linear C₁₀-C₁₃ alkyl benzene sulphonates; C₁₀-C₂₀ primary, branched-chain, linear-chain and random-chain alkyl sulphates (AS), preferred are linear alkyl sulphates, typically having the following formula:
CH₃(CH₂)_{X}CH₂-OSO₃⁻M⁺,
wherein, M is hydrogen or a cation which provides charge neutrality, preferred cations include sodium and ammonium cations, wherein x is an integer of at least 7, preferably at least 9; C₁₀-C₁₈ secondary (2,3) alkyl sulphates having the following formulae:

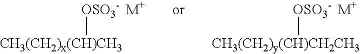

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. 6,020,303 and U.S. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof.

Preferred anionic detersive surfactants are selected from the group consisting of: linear or branched, substituted or unsubstituted, C₁₂-₁₈ alkyl sulphates; linear or branched, substituted or unsubstituted, C₁₀₋₁₈ alkylbenzene sulphonates, preferably linear C₁₀-₁₃ alkylbenzene sulphonates; linear or branched, substituted or unsubstituted alkyl alkoxylated sulphates having an average degree of alkoxylation of from1 to 20, preferably linear C₁₀-₁₈ alkyl ethoxylated sulphates having an average degree of ethoxylation of from 3 to 7; and mixtures thereof. Highly preferred are commercially available C₁₀-₁₃ linear alkylbenzene sulphonates. Highly preferred are linear C₁₀-₁₃ alkylbenzene sulphonates that are obtained by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

It may be preferred for the anionic detersive surfactant to be structurally modified in such a manner as to cause the anionic detersive surfactant to be more calcium tolerant and less likely to precipitate out of the wash liquor in the presence of free calcium ions. This structural modification could be the introduction of a methyl or ethyl moiety in the vicinity of the anionic detersive surfactant's head group, as this can lead to a more calcium tolerant anionic detersive surfactant due to steric hindrance of the head group, which may reduce the anionic detersive surfactant's affinity for complexing with free calcium cations in such a manner as to cause precipitation out of solution. Other structural modifications include the introduction of functional moieties, such as an amine moiety, in the alkyl chain of the anionic detersive surfactant; this can lead to a more calcium tolerant anionic detersive surfactant because the presence of a functional group in the alkyl chain of an anionic detersive surfactant may minimise the undesirable physicochemical property of the anionic detersive surfactant to form a smooth crystal structure in the presence of free calcium ions in the wash liquor. This may reduce the tendency of the anionic detersive surfactant to precipitate out of solution.

The composition preferably comprises alkoxylated anionic detersive surfactant; preferably from 0.1% to 10%, by weight of the composition, of alkoxylated anionic detersive surfactant. This is the optimal level of alkoxylated anionic detersive surfactant to provide good greasy soil cleaning performance, to give a good sudsing profile, and to improve the hardness tolerancy of the overall detersive surfactant system. It may be preferred for the composition to comprise from 3% to 5%, by weight of the composition, of alkoxylated anionic detersive surfactant, or it may be preferred for the composition to comprise from 1% to 3%, by weight of the composition, of alkoxylated anionic detersive surfactant.

Preferably, the alkoxylated anionic detersive surfactant is a linear or branched, substituted or unsubstituted C₁₂-₁₈ alkyl alkoxylated sulphate having an average degree of alkoxylation of from 1 to 30, preferably from 1 to 10. Preferably, the alkoxylated anionic detersive surfactant is a linear or branched, substituted or unsubstituted C₁₂-₁₈ alkyl ethoxylated sulphate having an average degree of ethoxylation of from 1 to 10. Most preferably, the alkoxylated anionic detersive surfactant is a linear unsubstituted C₁₂-₁₈ alkyl ethoxylated sulphate having an average degree of ethoxylation of from 3 to 7.

The alkoxylated anionic detersive surfactant may also increase the activity of any non-alkoxylated anionic detersive surfactant, if present, by making the non-alkoxylated anionic detersive surfactant less likely to precipitate out of solution in the presence of free calcium cations. Preferably, the weight ratio of non-alkoxylated anionic detersive surfactant to alkoxylated anionic detersive surfactant present in the composition is less than 5:1, or less than 3:1, or less than 1.7:1, or even less than 1.5:1. This ratio gives optimal whiteness maintenance performance combined with a good hardness tolerency profile and a good sudsing profile. However, it may be preferred that the weight ratio of non-alkoxylated anionic detersive surfactant to alkoxylated anionic detersive surfactant present in the composition is greater than 5:1, or greater than 6:1, or greater than 7:1, or even greater than 10:1. This ratio gives optimal greasy soil cleaning performance combined with a good hardness tolerency profile, and a good sudsing profile. Suitable alkoxylated anionic detersive surfactants are: Texapan LEST™ by Cognis; Cosmacol AES™ by Sasol; BES151™ by Stephan; Empicol ESC70/U™; and mixtures thereof.

Zeolite Builder

The composition comprises from 0% to less than 5%, or to 4%, or to 3%, or to 2%, or to 1%, by weight of the composition, of zeolite builder. It may even be preferred for the composition to be essentially free from zeolite builder. By essentially free from zeolite builder it is typically meant that the composition comprises no deliberately added zeolite builder. This is especially preferred if it is desirable for the composition to be very highly soluble, to minimise the amount of water-insoluble residues (for example, which may deposit on fabric surfaces), and also when it is highly desirable to have transparent wash liquor. Zeolite builders include zeolite A, zeolite X, zeolite P and zeolite MAP.

Phosphate Builder

The composition comprises from 0% to less than 5%, or to 4%, or to 3%, or to 2%, or to 1%, by weight of the composition, of phosphate builder. It may even be preferred for the composition to be essentially free from phosphate builder. By essentially free from phosphate builder it is typically meant that the composition comprises no deliberately added phosphate builder. This is especially preferred if it is desirable for the composition to have a very good environmental profile. Phosphate builders include sodium tripolyphosphate.

Silicate Salt

The composition optionally comprises from 0% to less than 5%, or to 4%,or to 3%, or to 2%, or to 1%, by weight of the composition, of a silicate salt. Whilst the composition may comprise silicate salt at a level of 5 wt% or greater, preferably the composition comprises less than 5 wt% silicate salt. It may even be preferred for the composition to be essentially free from silicate salt. By essentially free from silicate salt it is typically meant that the composition comprises no deliberately added silicate. This is especially preferred in order to ensure that the composition has very good dispensing and dissolution profiles, and to ensure that the composition forms a clear wash liquor upon dissolution in water. Silicate salts include water-insoluble silicates. Silicate salts include amorphous silicates and crystalline layered silicates (e.g. SKS-6). A preferred silicate salt is sodium silicate.

Adjunct Ingredients

The composition typically comprises adjunct ingredients. These adjunct ingredients include: detersive surfactants such as non-ionic detersive surfactants, cationic detersive surfactants, zwitterionic detersive surfactants, amphoteric detersive surfactants; preferred non-ionic detersive surfactants are C₈-₁₈ alkyl alkoxylated alcohols having an average degree of alkoxylation of from 1 to 20, preferably from 3 to 10, most preferred are C₁₂-₁₈ alkyl ethoxylated alcohols having an average degree of alkoxylation of from 3 to 10; preferred cationic detersive surfactants are mono-C₆-18 alkyl mono-hydroxyethyl di-methyl quaternary ammonium chlorides, more preferred are mono-C₈-₁₀ alkyl mono-hydroxyethyl di-methyl quaternary ammonium chloride, mono-C₁₀-₁₂ alkyl mono-hydroxyethyl di-methyl quaternary ammonium chloride and mono-C₁₀ alkyl mono-hydroxyethyl di-methyl quaternary ammonium chloride; source of peroxygen such as percarbonate salts and/or perborate salts, preferred is sodium percarbonate, the source of peroxygen is preferably at least partially coated, preferably essentially completely coated, by a coating ingredient such as a carbonate salt, a sulphate salt, a silicate salt, borosilicate, or mixtures thereof, including mixed salts thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; enzymes such as amylases, carbohydrases, cellulases, laccases, lipases, oxidases, peroxidases, proteases, pectate lyases and mannanases; suds suppressing systems such as silicone based suds suppressors; fluorescent whitening agents; photobleach; filler salts such as sulphate salts, preferably sodium sulphate; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as alkoxylated polyamines and ethoxylated ethyleneimine polymers; anti-redeposition components such as carboxymethyl cellulose and polyesters; perfumes; sulphamic acid or salts thereof; citric acid or salts thereof; dyes such as orange dye, blue dye, green dye, purple dye, pink dye, or any mixture thereof; carbonate salt such as sodium carbonate and/or sodium bicarbonate; carboxylate polymers such as co-polymers of maleic acid and acrylic acid.

Preferably, the composition comprises less than 1 wt% chlorine bleach and less than 1 wt% bromine bleach. Preferably, the composition is essentially free from bromine bleach and chlorine bleach. By “essentially free from” it is typically meant “comprises no deliberately added”.

Process for Preparing a Composition

The process for preparing the above described composition comprises the steps of: (i) preparing an aqueous mixture comprising an anionic detersive surfactant; (ii) subjecting the aqueous mixture to a first drying step, typically in a first drying zone, having a mean drying-duration time of less than 60 seconds and a mean drying rate of from 0.005 to 0.030 kg of water per kg of aqueous mixture per second to form a partially dried aqueous mixture; and (iii) subjecting the partially dried aqueous mixture to a second drying step, typically in a second drying zone, which can be the same or different zone to the first drying zone, the second drying step having a mean drying-duration time of at least 10 seconds and a mean drying rate of from 0.005 to less than 0.030 kg of water per kg of partially dried aqueous mixture per second to form a solid laundry detergent composition. Preferably, the ratio of the mean drying rate in the first drying step to the mean drying rate in the second drying step is greater than 1:1, preferably greater than 2:1, or greater than 3:1, or even greater than 4:1. Preferably, the ratio of the mean drying-duration time of the second drying step to the mean drying-duration time of the first drying step is greater than 1:1, preferably greater than 2:1, or even greater 3:1, or greater than 4:1.

Preferably, the ratio of the inlet gas temperature of the first drying step to the inlet gas temperature of the second drying step is at least 1:1, or at least 2:1, or even at least 3:1. These preferred drying profiles ensure an adequately dried laundry detergent composition whilst minimizing the risk of thermal degradation of ingredients present in the laundry detergent composition.

The first drying step and second drying step can be carried out in the same drying equipment: i.e. the first and second drying zones can be the same zone. Preferably the first drying step and the second drying step are carried out in separate drying equipment (i.e. separate drying zones), although the separate drying equipment may be in a close-coupled configuration; for example: the first drying step may be carried out in a spray-drying tower and the second drying step may be carried out in a fluid bed dryer that is positioned at the base of the spray-drying tower of the first drying step.

Step (i): preparing an aqueous mixture comprising an anionic detersive surfactant

During step (i), an aqueous mixture comprising an anionic detersive surfactant is prepared. The aqueous mixture preferably comprises one or more adjunct ingredients, especially adjunct ingredients selected from: sodium carbonate, sodium bicarbonate, carboxylate polymers, sodium sulphate, enzymes such as protease, lipase, amylase, fluorescent whitening agents, soil dispersants, and mixtures thereof. Step (i) can be carried out in any suitable vessel such as a crutcher.

Step (ii): subjecting the aqueous mixture to a first drying step

During step (ii), the aqueous mixture is subjected to a first drying step to form a partially dried aqueous mixture. The first drying step preferably has a mean drying-duration period of less than 60 seconds, preferably less than 40 seconds, or less than 20 seconds, or even less than 15 seconds. This mean drying-duration period is typically the mean residency time of the aqueous mixture in the first drying zone.

The first drying step preferably has a mean drying rate of from 0.005 to 0.030, more preferably from 0.01, or from 0.05, or from 0.1, and preferably to 0.025, or to 0.020 kg of water per kg of aqueous mixture per second. This mean drying rate is typically determined by calculating the water loss from the aqueous mixture during the first drying step, typically by a distillation moisture method using liquid paraffin having a boiling point of 160° C. This mean drying rate is the average moisture loss from the aqueous mixture during the first drying step divided by the mean drying-duration time of the first drying step.

Typically, the aqueous mixture is atomized prior to being subjected to the first drying step. The atomization means can be nozzles through which the aqueous mixture passes, typically under pressure, prior to being subjected to the first drying step. Other suitable atomization means include rotary disk atomizers or two fluid nozzles using compressed air. Preferably, the first drying step is carried out in a spray-drying tower, typically a co-current spray-drying tower or a counter-current spray-drying tower.

Step (iii): subjecting the aqueous mixture to a second drying step

During step (iii), the partially dried aqueous mixture is subjected to a second drying step. The second drying step preferably has a mean drying-duration period of at least 10 seconds, preferably at least 20seconds, or at least 30 seconds, or at least 40 seconds, or even at least 50 seconds, or at least 60 seconds. This mean drying-duration period is typically the mean residency time of the partially dried aqueous mixture in the second drying zone.

The second drying step preferably has a mean drying rate of from 0.0005 to less than 0.030, preferably from 0.001, or from 0.005, or from 0.01, or from 0.05, or from 0.1, and preferably to less than 0.025, or to less than 0.020 kg of water per kg of partially dried aqueous mixture per second. This mean drying rate is typically determined by calculating the water loss from the partically dried aqueous mixture during the second drying step, typically by a distillation moisture method using liquid paraffin having a boiling point of 160° C. This mean drying rate is the average moisture loss from the partially dried aqueous mixture divided by the mean drying-duration time of the second drying step.

Optionally, a liquid binder such as water may be contacted to the partially dried aqueous mixture during the second drying step, especially when the second drying step is carried out in a fluid bed. This liquid binder helps to control the particle growth of the particles that are formed during the second drying step and ensures that the solid laundry detergent composition has good physical characteristics including a narrow particle size distribution which improves the dissolution profile of the composition.

### EXAMPLES

The following aqueous mixture is prepared:

| Component | wt % aqueous mixture |
|---|---|
| A compound having the following general structure: | 1.23 |
| bis((C₂H₅O)(C₂H₄O)n)(CH₃)—N⁺—CₓH₂ₓ—N⁺—(CH₃)-bis((C₂H₅O)(C₂H₄O)n), | |
| wherein n = from 20 to 30, and x = from 3 to 8, or sulphated or | |
| sulphonated variants thereof | |
| Ethylenediamine disuccinic acid | 0.35 |
| Fluorescent whitening agent | 0.12 |
| Magnesium sulphate | 0.72 |
| Acrylate/maleate copolymer | 6.41 |
| Linear alkyl benzene sulphonate | 12.18 |
| Hydroxyethane di(methylene phosphonic acid) | 0.32 |
| Sodium carbonate | 18.87 |
| Sodium sulphate | 32.59 |
| Soap | 0.78 |
| Water | 26.00 |
| Miscellaneous | 0.43 |
| Total parts | 100.00 |

The aqueous mixture is dried in the following manner:

55 kg of the above described aqueous is heated to 70° C. and atomized and sprayed into a co-current spray-drying tower with a gas (air) inlet temperature of 200° C. The aqueous slurry is dried for 10 seconds to produce a partially dried aqueous mixture comprising 10%, by weight of the partially dried aqueous mixture, of water. The partially dried aqueous mixture then fall directly into a fluid bed dryer having a gas (air) inlet temperature of 130° C. The partially dried aqueous mixture is dried for 90 seconds to produce solid particles comprising 1%, by weight of the solid particles, of water. The solid particles leave the fluid bed dryer via a pneumatic dump valve.

The solid particles comprise the following composition:

| Component | wt % aqueous mixture |
|---|---|
| A compound having the following general structure: | 1.65 |
| bis((C₂H₅O)(C₂H₄O)n)(CH₃)—N⁺—CₓH₂ₓ—N⁺—(CH₃)-bis((C₂H₅O)(C₂H₄O)n), | |
| wherein n = from 20 to 30, and x = from 3 to 8, or sulphated or sulphonated variants thereof | |
| Ethylenediamine disuccinic acid | 0.47 |
| Fluorescent whitening agent | 0.16 |
| Magnesium sulphate | 0.96 |
| Acrylate/maleate copolymer | 8.58 |
| Linear alkyl benzene sulphonate | 16.30 |
| Hydroxyethane di(methylene phosphonic acid) | 0.43 |
| Sodium carbonate | 25.25 |
| Sodium sulphate | 43.61 |
| Soap | 1.04 |
| Water | 1.00 |
| Miscellaneous | 0.55 |
| Total parts | 100.00 |

1. A process for preparing a solid laundry detergent composition comprising:
(a) anionic detersive surfactant;
(b) from 0% to less than 5%, by weight of the composition, of zeolite builder;
(c) from 0% to less than 5%, by weight of the composition, of phosphate builder; and 6p1 (d) optionally, from 0% to less than 5%, by weight of the composition, of silicate salt; wherein the process comprises the steps of:
(i) preparing an aqueous mixture comprising an anionic detersive surfactant;
(ii) subjecting the aqueous mixture to a first drying step having a mean drying-duration time of less than 60 seconds and a mean drying rate of from 0.005 to 0.030 kg of water per kg of aqueous mixture per second to form a partially dried aqueous mixture; and
(iii) subjecting the partially dried aqueous mixture to a second drying step having a mean drying-duration time of at least 10 seconds and a mean drying rate of from 0.0005 to less than 0.030 kg of water per kg of partially dried aqueous mixture per second to form a solid laundry detergent composition, wherein the ratio of the mean drying rate in the first drying step to the mean drying rate in the second drying step is greater than 1: 1, and wherein the ratio of the mean drying-duration time of the second drying step to the mean drying-duration time of the first drying step is greater than 1:1.

2. A process according to claim 1, wherein the ratio of the mean drying rate in the first drying step to the mean drying rate in the second drying step is greater than 3:1.

3. A process according to claim 1, wherein the ratio of the inlet gas temperature of the first drying step to the inlet gas temperature of the second drying step is at least 1:1.

4. A process according to claim 1, wherein the first drying step is carried out in a spray-drying tower.

5. A process according to claim 1, wherein the second drying step is carried out in a fluid bed dryer.

6. A process according to claim 1, wherein the composition is essentially free from zeolite builder and phosphate builder.

7. A process according to claim 1, wherein the composition comprises:
(i) a linear or branched, substituted or unsubstituted C₈-₂₄ alkyl benzene sulphonate; and
(ii) a linear or branched substituted or unsubstituted C₈-₂₄ alkyl alkoxylated sulphate having an average degree of alkoxylation of from 1 to 20.
